(19) United States
(12) Patent Application Publication
(10) Pub. No.: US 2023/0205169 A1
(43) Pub. Date: Jun. 29, 2023

(54) BUILT-IN RETRIEVAL MODE FOR UNIT OF MEASUREMENT CONVERSION

(71) Applicant: AVEVA SOFTWARE, LLC, Lake Forest, CA (US)

(72) Inventors: Bandana Chand, Lake Forest, CA (US); Sripraneeth Nara, Lake Forest, CA (US); Elliott Middleton, Tyler, TX (US); Jatin Ranawat, Tustin, CA (US)

(21) Appl. No.: 18/088,012

(22) Filed: Dec. 23, 2022

Related U.S. Application Data
(60) Provisional application No. 63/293,431, filed on Dec. 23, 2021.

(51) Int. Cl. G05B 19/408

(52) U.S. Cl. CPC G05B 19/408; G05B 2219/32128

(57) ABSTRACT

Some embodiments of the disclosure are direct to a system for transforming data values associated with an industrial component such as a pump or storage tank into a different form than the data values received from a sensor were intended. In some embodiments, the system is configured to determine a data values for a component not attached to a sensor by using data values from components with sensors. In some embodiments, the system is configured to initiate a self-healing operation where equivalent values are produced for components when actual sensor values stop being received for those components. In some embodiments, the system is able to control various industrial facility components using the equivalent values. In some embodiments, the system is able to display a unit of measure for a component in a different unit of measure than that provided by a sensor.

### CROSS-REFERENCE TO RELATED APPLICATION

This application claims the benefit of and priority to U.S. Provisional Application No. 63/293,431, filed Dec. 23, 2022, which is hereby incorporated herein by reference in its entirety for all purposes.

### BACKGROUND

Unit conversations within the same dimensions are common in engineering. For example, converting from Celsius to Fahrenheit is used quite often to describe the same temperature to those in different regions in their respective customary units. Other examples of interdimensional conversions include meters to feet, millimeters to centimeters, miles to kilometers, etc. However, there are currently no manufacturing control systems that incorporate extradimensional conversions such as between a quantity and a rate. For example, there are no systems in the prior art configured to take a quantifiable level reading, such as gallons present in a tank recorded at specific intervals with a day, and then convert those values into a flowrate, such as liters per hour, and vice versa. While the desired information can be obtained through various mathematical manipulations, conventional routines are infeasible to apply to thousands or even millions of data points in substantially real time.

Manufacturing environments rely on data collection to identify plant inefficiencies and/or to execute control operations to obtain a desired quality and yield. Currently, to obtain a flowrate from a pipe, for example, a flowmeter must be installed, and the flowmeter data must be collected and stored as a rate and analyzed in that dimension. This failure of others to develop a system that can replace rate-based meters with a monitoring system that does not require physical components dramatically increases both manufacturing facility construction and maintenance costs as well as costs associated with collecting and storing associated digital information.

Therefore, there is a need in the art for a system that can convert quantifiable values to rates in substantially real time and vice versa to identify inefficiencies in a manufacturing environment and provide system control to components without sensors based at least in part on the conversions and/or new monitoring calculations derived from existing sensors.

### SUMMARY

Some embodiments described here are directed to an industrial control system. In some embodiments the industrial control system comprises one or more computers comprising one or more processors and one or more non-transitory computer readable media, the one or more non-transitory computer readable media comprising instructions stored thereon that when executed cause the one or more computers to implement one or more program steps. In some embodiments, the instructions include a step to receive, by the one or more processors, a first sensor output, the first sensor output comprising one or more first data values from a first component within an industrial process. In some embodiments, the instructions include a step to associate, by the one or more processors, the one or more first data values with a first unit of measure. In some embodiments, the instructions include a step to receive, by the one or more processors, a second sensor output, the second sensor output comprising one or more second data values from a second component within the industrial process. In some embodiments, the instructions include a step to associate, by the one or more processors, the one or more second data values with a second unit of measure.

In some embodiments, the instructions include a step to generate, by the one or more processors, a graphical user interface (GUI), the graphical user interface comprising a visual representation of at least the first component and the second component. In some embodiments, the instructions include a step to generate, by the one or more processors, a first data display on the GUI comprising at least one of the one or more first data values in association with the first component, the first data display comprising the first unit of measure. In some embodiments, the instructions include a step to execute, by the one or more processors, a transformation of the one or more second data values to obtain one or more transformed data values. In some embodiments, the instructions include a step to associate, by the one or more processors, the one or more transformed data values with the first unit of measure. In some embodiments, the instructions include a step to generate, by the one or more processors, a second data display on the GUI comprising at least one of the one or more transformed data values in association with the second component, the second data display comprising the first unit of measure.

In some embodiments, the one or more non-transitory computer readable media further comprise instructions stored thereon that when executed cause the one or more computers to generate, by the one or more processors, a visual representation of at least a third component within the industrial process that does not comprise a sensor on the GUI. In some embodiments, the instructions include a step to calculate, by the one or more processors, one or more equivalent third data values using the one or more first data values and/or the one or more second data values. In some embodiments, the instructions include a step to display, by the one or more processors, the one or more equivalent third data values on the GUI in association with the third component. In some embodiments, the one or more equivalent third data values comprise the first unit of measure. In some embodiments, the one or more equivalent third data values are calculated using the one or more first data values and/or the one or more second data values as the one or more first data values and/or the one or more second data values are received in substantially real time.

In some embodiments, the one or more non-transitory computer readable media further comprise instructions stored thereon that when executed cause the one or more computers to receive, by the one or more processors, one or more time data points associated with a time the one or more first data values and/or the one or more second data values were received. In some embodiments, the instructions include a step to transform, by the one or more processors, the one or more equivalent third data values into one or more transformed third data values using the one or more first data values and/or the one or more second data values and the one or more time data points. In some embodiments, the one or more transformed third data values comprise a transformed third unit of measure comprising a time rate of change.

Some embodiments are directed to system for self-healing data collection upon loss of a data collection signal. In some embodiments, the one or more non-transitory computer readable media comprise instructions stored thereon that when executed cause the one or more computers to receive, by the one or more processors, a first sensor output, the first sensor output comprising one or more first data values from a first component within an industrial process. In some embodiments, the instructions include a step to associate, by the one or more processors, the one or more first data values with a first unit of measure. In some embodiments, the instructions include a step to receive, by the one or more processors, a second sensor output, the second sensor output comprising one or more second data values from a second component within the industrial process. In some embodiments, the instructions include a step to associate, by the one or more processors, the one or more second data values with a second unit of measure. In some embodiments, the instructions include a step to generate, by the one or more processors, a graphical user interface (GUI), the graphical user interface comprising a visual representation of at least the first component and the one or more first data values.

In some embodiments, if the first sensor output is not received within a pre-determined period of time, the instructions further cause the one or more computers to implement a self-healing operation, the self-healing operation causing the one or more computers to implement steps that include a step to calculate, by the one or more processors, one or more equivalent first data values using the one or more second data values. In some embodiments, the instructions include a step to display, by the one or more processors, the one or more equivalent first data values on the GUI in association with the first component. In some embodiments, the instructions include a step to associate, by the one or more processors, the one or more equivalent first data values with the first unit of measure.

In some embodiments, the one or more non-transitory computer readable media further comprise instructions stored thereon that when executed cause the one or more computers to generate, by the one or more processors, a visual representation of at least a third component within the industrial process that is not receiving data from a sensor on the GUI. In some embodiments, the instructions include a step to calculate, by the one or more processors, one or more equivalent third data values using the one or more first data values and/or the one or more second data values. In some embodiments, the instructions include a step to display, by the one or more processors, the one or more equivalent third data values on the GUI in association with the third component.

In some embodiments, the one or more equivalent third data values comprise the first unit of measure. In some embodiments, the one or more equivalent third data values are calculated using the one or more first data values and/or the one or more second data values as the one or more first data values and/or the one or more second data values are received in substantially real time.

In some embodiments, the one or more non-transitory computer readable media further comprising instructions stored thereon that when executed cause the one or more computers to receive, by the one or more processors, one or more time data points associated with a time the one or more first data values and/or the one or more second data values were received. In some embodiments, the instructions include a step to transform, by the one or more processors, the one or more equivalent third data values into one or more transformed third data values using the one or more first data values and/or the one or more second data values and the one or more time data points. In some embodiments, the one or more transformed third data values comprise a transformed third unit of measure comprising a time rate of change.

Some embodiments are directed to an industrial control system comprising instructions stored thereon that when executed cause the one or more computers to receive, by the one or more processors, a first sensor output, the first sensor output comprising one or more first data values from a first component within an industrial process. In some embodiments, the instructions include a step to associate, by the one or more processors, the one or more first data values with a first unit of measure. In some embodiments, the instructions include a step to receive, by the one or more processors, a second sensor output, the second sensor output comprising one or more second data values from a second component within the industrial process. In some embodiments, the instructions include a step to associate, by the one or more processors, the one or more second data values with a second unit of measure. In some embodiments, the instructions include a step to generate, by the one or more processors, a graphical user interface (GUI), the graphical user interface comprising a visual representation of at least a third component within the industrial process that does not comprise a sensor. In some embodiments, the instructions include a step to calculate, by the one or more processors, one or more equivalent third data values using the one or more first data values and/or the one or more second data values. In some embodiments, the instructions include a step to display, by the one or more processors, the one or more equivalent third data values on the GUI in association with the third component.

In some embodiments, if the first sensor output is not received within a pre-determined period of time, the instructions further cause the one or more computers to implement a self-healing operation, the self-healing operation causing the one or more computers to calculate, by the one or more processors, one or more equivalent first data values using the one or more second data values. In some embodiments, the one or more non-transitory computer readable media further comprise instructions stored thereon that when executed cause the one or more computers to control, by the one or more processors, a physical attribute of the third component using the one or more equivalent third data values. In some embodiments, the one or more non-transitory computer readable media further comprise instructions stored thereon that when executed cause the one or more computers to control, by the one or more processors, a physical attribute of the first component using the one or more equivalent first data values. In some embodiments, the one or more non-transitory computer readable media further comprise instructions stored thereon that when executed cause the one or more computers to control, by the one or more processors, a physical attribute of the second component using the one or more equivalent second data values, where the system is configured to enable a user to input and/or associate an equivalent value formula for any component and/or object in a process simulation and/or control system. In some embodiments, the system is configured to generate new tags based on one or more equivalent data values and associate the new tags with a particular component.

In some embodiments, the one or more non-transitory computer readable media further comprising instructions stored thereon that when executed cause the one or more computers to receive, by the one or more processors, one or more time data points associated with a time the one or more first data values. In some embodiments, the instructions include a step to transform, by the one or more processors, the one or more first data values into one or more transformed first data values using the one or more first data values and the one or more time data points. In some embodiments, the one or more transformed first data values comprise a transformed first unit of measure comprising a time rate of change.

### DRAWING DESCRIPTION

FIG. 1 shows a user interface comprising a transformation selection window for time series data according to some embodiments.

FIG. 2 shows a conversion of the time series rate unit data of FIG. 1 into a quantity data for a given day according to some embodiments.

FIG. 3 illustrates a computer system enabling or comprising the systems and methods described herein in accordance with some embodiments.

### DETAILED DESCRIPTION

In some embodiments, systems and methods described herein (referred to herein as the “system”) are directed to performing extradimensional conversions for manufacturing process (also referred to as a/the “process” herein) visualization and control. In some embodiments, the system comprises one or more manufacturing control systems configured to collect data from one or more system components (e.g., manufacturing equipment, pumps, pipes, sensors, sections of manufacturing processes, etc.) and generate one or more graphical user interfaces (GUIs) comprising one or more equipment component parameters and/or one or more control options for the one or more equipment components. In some embodiments, the one or more manufacturing control systems comprise a supervisory control and data acquisition (SCADA) system.

In some embodiments, the system is configured to display one or more extradimensional conversion windows. As used herein, an extradimensional conversion is a transformation of raw data from a first dimension to a second dimension using units not associated with the raw data when the raw data is collected. A non-limiting example of an extradimensional conversion includes a transformation of volume (e.g., gallons, liters) to volumetric flowrate (e.g., gallons/day, liters/hr.) according to some embodiments.

In some embodiments, when integrated into a manufacturing environment, the extradimensional conversion provides the benefit of being able to model and/or monitor a portion of the process that does not include a sensor. As a non-limiting example, a fluid supply tank storing a first raw material may comprise a level sensor which sends periodic measurements in the form of liters as raw data to a database (e.g., a conventional industrial process historian database) according to some embodiments. In some embodiments, the fluid supply tank is connected to a reactor where it is refined into a first chemical and a second chemical which are stored in a first refined storage tank and a second refined storage tank, respectively. In some embodiments, each of the first and second storage tanks are also monitored by respective level sensors.

In some manufacturing processes, different raw materials yield different volumes of chemicals when refined. This is especially true of organic based raw materials collected in different regions. In some embodiments, these different raw materials may be fed to and stored in the same fluid supply tank while awaiting refinement. In some embodiments, the differences in the raw materials, or mixtures thereof, will cause different flowrates of refined material into the first and second storage tanks as different organic material enters the reactor. Because of the change in flowrates in real time, it is not possible to create a fixed formula to predict when the first and second storage tanks will reach maximum capacity. This prediction issue creates a scheduling problem within a manufacturing execution system (“MES”) as the MES does not have the information to adjust scheduling to accurately reflect when an amount of refined material will be available. This in turn creates downtime as scheduled changes for equipment lineups or bringing other manufacturing facilities online or offline are not executed because the expected time to reach a maximum capacity has changed.

In this scenario, the monitoring of flowrates using a flowmeter in all three lines would give real (or substantially real) time (“hereinafter referred to as “real time”) indication of a change in flow through each line. However, this is an expensive process that requires coordination of multiple resources and sometimes complete manufacturing facility shutdown while upgrades take place. In some embodiments, the system includes a self-healing operation configured to replace sensor obtained raw data with calculated data by using one or more of the methods described herein. In some embodiments, the system is configured to enable a user to select between measured (i.e., by a sensor) and calculated (i.e., by the system).

In some embodiments, these self-healing operations improve safety and allow for continued production in the event of a lost sensor. In some embodiments, the self-healing operation saves cost by not needing to install multiple redundant sensors and saves computer resources by not needing to process and store additional data from the redundant sensors.

In some embodiments, the system is configured to execute the self-healing operation including extradimensional transformation upon detection of a pre-determined time gap between sensor data collection events. By implementing the system described herein, no additional hardware or downtime is needed to obtain the same redundant information according to some embodiments.

In some embodiments, the system includes a user interface. In some embodiments, the user interface is configured to display a transformation window. In some embodiments, the transformation window is configured to enable a user to associate a unit with raw data. In some embodiments, the transformation window is configured to enable a user to associate a unit type to raw data that already has a unit assigned to it by a different data collection system. In some embodiments, this assignment capability provides the benefit of being able to standardize unit labels across multiple sensor types.

As a non-limiting example, if a factory control system uses a capital “L” for liters for one sensor, a lowercase “l” for a second sensor, and “liters” for another sensor, the system will assign a designation of the user choice, for example “L” to all sensors to ensure consistency between calculations by the system according to some embodiments. In some embodiments, the system is configured to automatically assign the incoming unit to the unit type before executing the extradimensional transformation.

In some embodiments, the system comprises a unit library comprising one or more of pre-defined quantity units and rate units. In some embodiments, a quantity unit comprises a unit that does not change over time, where a rate unit comprises a unit that changes over time and/or is a function of another unit. In some embodiments, the transformation window comprises one or more unit library links to the unit library. In some embodiments, the system is configured to provide the transformation window and/or the one or more unit library links when it attempts a calculation involving one or more sources of raw data that has not been assigned a unit type. In some embodiments, this improves exception handling as only pre-defined unit types are available to an end user within the transformation window. In some embodiments, the transformation window comprises an edit interface configured to enable a user to define unit types and/or define the predefined unit types available withing the unit window.

In some embodiments, the system is configured to execute the extradimensional transformation in real time. As a non-limiting example, while raw data may be collected by a manufacturing system and stored as a quantity unit. Instead of storing the extradimensional transformation of the quantity unit into a rate unit for each data point, in some embodiments, the system is configured to execute the extradimensional transformation at the time of request. In some embodiments, the system is configured to execute the extradimensional transformation at predetermined time intervals. As a non-limiting example, if a sensor collects quantity level data every second, but a level per hour rate is desired for a control system or graphical display, the system is configured to request the previous hour's quantity level data and execute the extradimensional transformation once per hour, saving processing resources by not continuously calculating rate change after every data point is collected.

In some embodiments, the system is configured to execute a real time extradimensional transformation. In some embodiments, a real time extradimensional transformation includes transforming the raw data into a rate unit after each data point is collected. In some embodiments, the system is configured to generate a warning message if the rate of a monitored component of a process changes beyond a predetermined limit. In some embodiments, the system is configured to interface with an IVIES system to update scheduling in real time based on the change in rate of a monitoring component.

In some embodiments, the system is configured to interface with a control system to alternate one or more component parameters in response to a change in rate. Existing systems do not have this functionality, and “back of the envelope” hand calculations would not be able to identify these real time changes until it is too late for them to be corrected.

In some embodiments, the system is configured to perform mathematical operations for ad hoc expressions. In some embodiments, ad hoc expressions include mathematical formulas that comprise different units. A non-limiting example of an ad hoc expression may include 60 L/min+12 L/sec, where liters per minute is the desired format. In some embodiments, the system is configured to automatically convert one or more rate units and/or associated values into a single rate unit for the mathematical operation. In some embodiments, this functionality enables rates to be determined for components not supported by sensor data collection.

In some embodiments, the system is configured to determine a rate within a component not supported by sensor data collection. As a non-limiting example, a first, second, and third storage tank may each supply a raw material to a manifold by a first, second, and third pipe, respectively, where the three sources are combined into a single outlet according to some embodiments. In some embodiments, the manifold has a single outlet monitored by a flowmeter in mL/sec, where the first and second storage tanks are monitored by a level sensor, and the third storage tank is a railcar with no active sensors. In some embodiments, the system is configured to determine the flowrate through the first and second pipes as previously described and is also configured to subtract these flowrates from the single outlet sensor monitored flowrate to give an accurate reporting of the flowrate from the railcar. In some embodiments, an increase in contribution to the total outlet flowrate from each storage tank could be an indication the railcar is empty. Therefore, by using some of the systems and methods described herein, monitoring of components without sensors is readily achieved.

In some embodiments, the system is able to transform gauge pressure to absolute pressure. In some embodiments, the system is configured to receive a pressure input from an atmospheric pressure source (e.g., barometer, weather service) and add the atmospheric pressure to the gauge pressure to give an indication of absolute pressure before performing one or more operations described herein.

In some embodiments, the system comprises a historian transfer operation. In some embodiments, the system comprises a first historian and a second historian. In some embodiments, the first historian is configured to record the raw time series data as described herein. In some embodiments, the historian transfer operation is configured to apply one or more extradimensional transformations to the raw data and store the one or more extradimensional transformations in the second historian as summary data. In some embodiments, the raw time series data is also transferred to the second historian. In some embodiments, the raw time series data is not transferred to the second historian, and only the summary data is transferred to the second historian, thereby saving valuable computer storage resources.

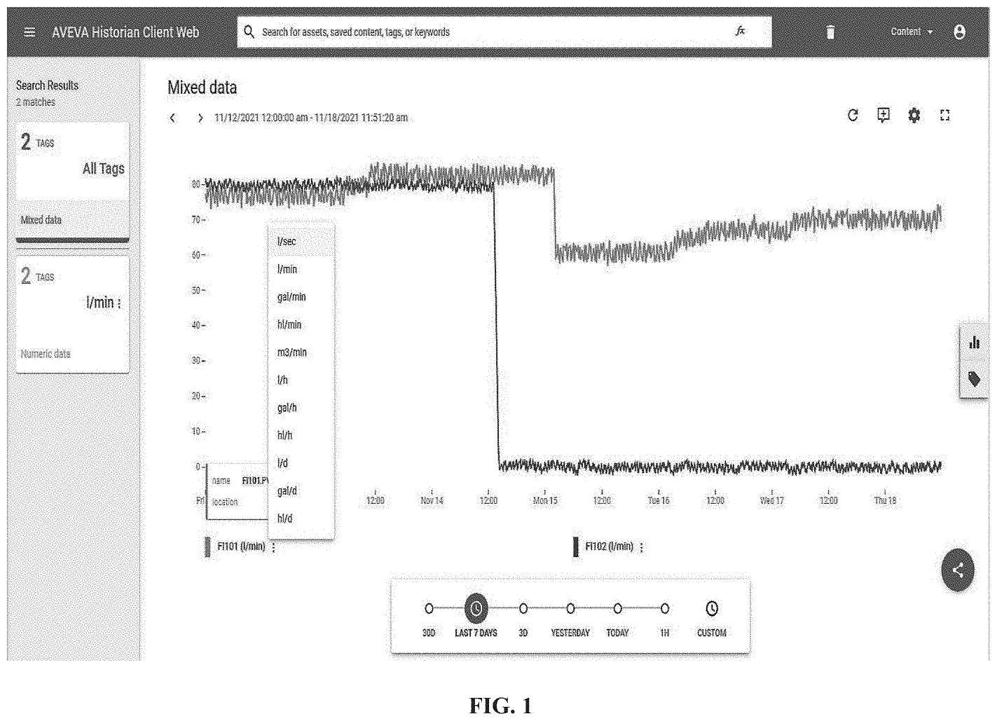

FIG. 1 shows a user interface comprising a transformation selection window for time series data according to some embodiments. In this non-limiting example, the measurements are stored approximately every 2 seconds and the chart summarizes ˜600K stored values according to some embodiments. In some embodiments, the sensor is reporting values in 1/min (a volumetric flow), but by selecting the “kabob” menu next to “FI101 (1/min)” or the one next to the “1/min” on the tile at the left, it is possible to request alternate units according to some embodiments. In some embodiments, selecting a unit from the tile applies to all the tags with the same units. In some embodiments, the conversion calculation is applied to all the displayed values.

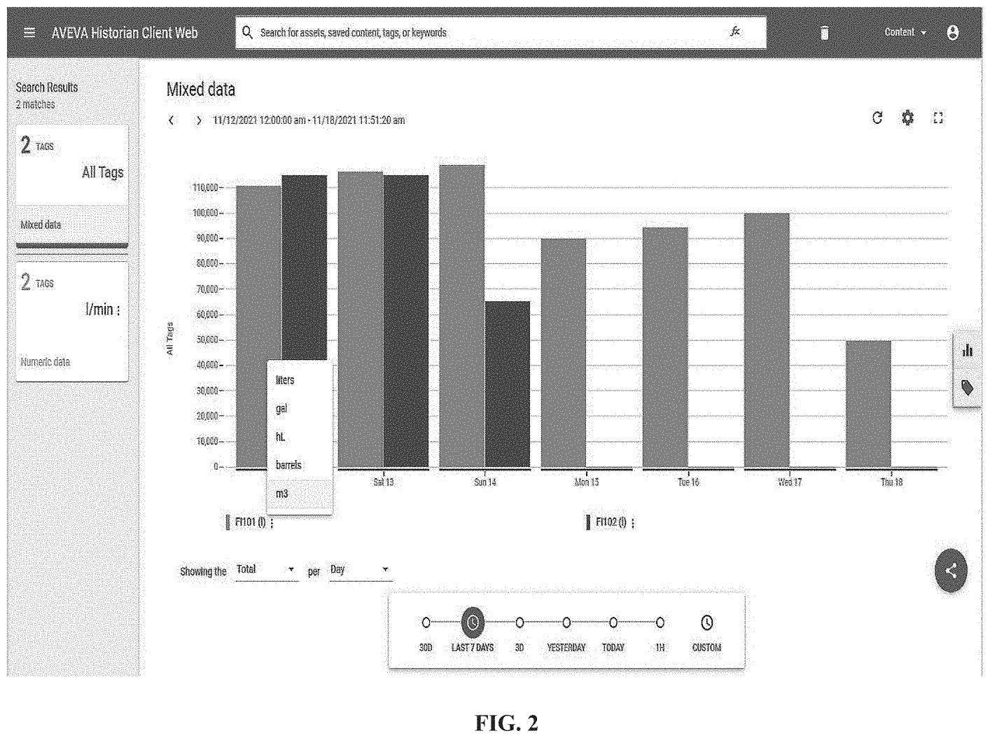

FIG. 2 shows a conversion of the time series rate unit data of FIG. 1 into a quantity data for a given day according to some embodiments. As with the trend chart, this conversion is also applied late in the processing, so that in the total case, the system is only converting 7 values (1 per day) per pen, not the ˜300K stored values according to some embodiments.

In some embodiments, within each dimension (e.g., volume), there exists a base unit (e.g., liters) where all other units within that dimension are defined in terms of that base unit (e.g., m³=1000 liters). In some embodiments, the system is configured to execute conversions between these derived units and the base units (e.g., m³ to liters) or liters to m³). In some embodiments, the system is also configured to execute conversions between derived units (e.g., m³ to gallons and gallons to m³) even though there are no direct conversions between these units defined in the system. In some embodiments, the system is configured to automatically execute two or more conversions (e.g., m³ to liters, then liters to gallons) automatically in response a conversion request. In some embodiments, this saves computer resources because when a user requests a result in gallons and the values are stored in m³, the system looks up both the conversion factors and offsets (e.g., m³ to liters and liters to gallons) and calculates the new derived conversion factor and offset from them once, and then applies that to all the values (e.g., ˜700 values for the trend example above) during extradimensional transformation and/or conversion.

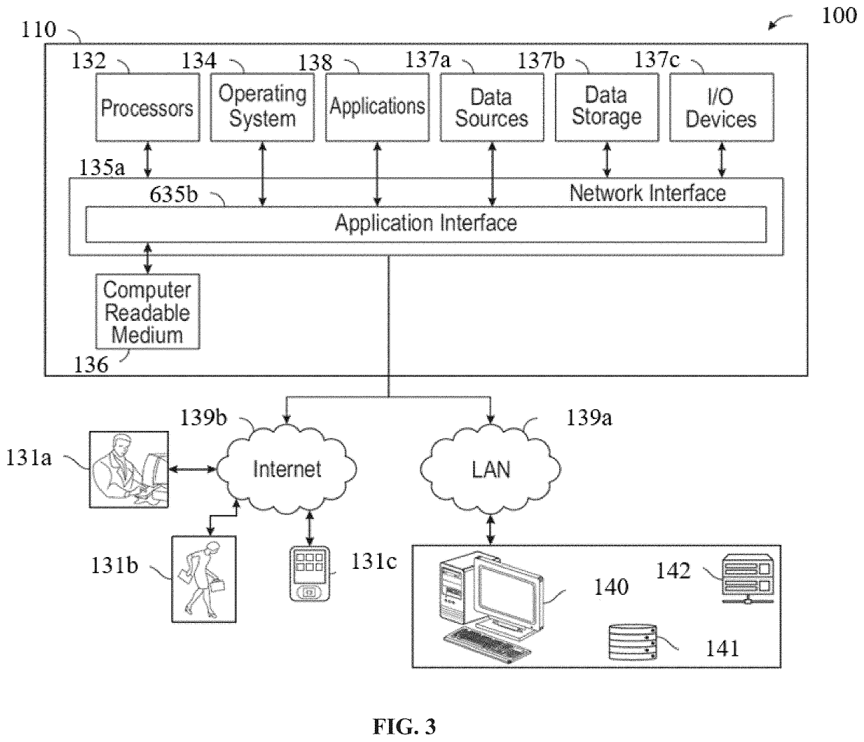

FIG. 3 illustrates a computer system 110 enabling or comprising the systems and methods in accordance with some embodiments of the system. In some embodiments, the computer system 110 can operate and/or process computer-executable code of one or more software modules of the aforementioned system and method. Further, in some embodiments, the computer system 110 can operate and/or display information within one or more graphical user interfaces (e.g., HMIs) integrated with or coupled to the system.

In some embodiments, the computer system 110 can comprise at least one processor 132. In some embodiments, the at least one processor 132 can reside in, or coupled to, one or more conventional server platforms (not shown). In some embodiments, the computer system 110 can include a network interface 135a and an application interface 135b coupled to the least one processor 132 capable of processing at least one operating system 134. Further, in some embodiments, the interfaces 135a, 135b coupled to at least one processor 132 can be configured to process one or more of the software modules (e.g., such as enterprise applications 138). In some embodiments, the software application modules 138 can include server-based software, and can operate to host at least one user account and/or at least one client account, and operate to transfer data between one or more of these accounts using the at least one processor 132.

With the above embodiments in mind, it is understood that the system can employ various computer-implemented operations involving data stored in computer systems. Moreover, the above-described databases and models described throughout this disclosure can store analytical models and other data on computer-readable storage media within the computer system 110 and on computer-readable storage media coupled to the computer system 110 according to various embodiments. In addition, in some embodiments, the above-described applications of the system can be stored on computer-readable storage media within the computer system 110 and on computer-readable storage media coupled to the computer system 110. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 110 can comprise at least one computer readable medium 136 coupled to at least one of at least one data source 137a, at least one data storage 137b, and/or at least one input/output 137c. In some embodiments, the computer system 110 can be embodied as computer readable code on a computer readable medium 136. In some embodiments, the computer readable medium 136 can be any data storage that can store data, which can thereafter be read by a computer (such as computer 140). In some embodiments, the computer readable medium 136 can be any physical or material medium that can be used to tangibly store the desired information or data or instructions and which can be accessed by a computer 140 or processor 132. In some embodiments, the computer readable medium 136 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 136 can transmit or carry instructions to a remote computer 140 and/or at least one user 131, including a router, private or public network, or other transmission or channel, both wired and wireless. In some embodiments, the software application modules 138 can be configured to send and receive data from a database (e.g., from a computer readable medium 136 including data sources 137a and data storage 137b that can comprise a database), and data can be received by the software application modules 138 from at least one other source. In some embodiments, at least one of the software application modules 138 can be configured within the computer system 110 to output data to at least one user 131 via at least one graphical user interface rendered on at least one digital display.

In some embodiments, the computer readable medium 136 can be distributed over a conventional computer network via the network interface 135a where the system embodied by the computer readable code can be stored and executed in a distributed fashion. For example, in some embodiments, one or more components of the computer system 110 can be coupled to send and/or receive data through a local area network (“LAN”) 139a and/or an internet coupled network 139b (e.g., such as a wireless internet). In some embodiments, the networks 139a, 139b can include wide area networks (“WAN”), direct connections (e.g., through a universal serial bus port), or other forms of computer-readable media 136, or any combination thereof.

In some embodiments, components of the networks 139a, 139b can include any number of personal computers 140 which include for example desktop computers, and/or laptop computers, or any fixed, generally non-mobile internet appliances coupled through the LAN 139a. For example, some embodiments include one or more of personal computers 140, databases 141, and/or servers 142 coupled through the LAN 139a that can be configured for any type of user including an administrator. Some embodiments can include one or more personal computers 140 coupled through network 139b. In some embodiments, one or more components of the computer system 110 can be coupled to send or receive data through an internet network (e.g., such as network 139b). For example, some embodiments include at least one user 131a, 131b, is coupled wirelessly and accessing one or more software modules of the system including at least one enterprise application 138 via an input and output (“I/O”) 137c. In some embodiments, the computer system 110 can enable at least one user 131a, 131b, to be coupled to access enterprise applications 138 via an I/O 137c through LAN 139a. In some embodiments, the user 131 can comprise a user 131a coupled to the computer system 110 using a desktop computer, and/or laptop computers, or any fixed, generally non-mobile internet appliances coupled through the internet 139b. In some embodiments, the user can comprise a mobile user 131b coupled to the computer system 110. In some embodiments, the user 131b can connect using any mobile computing 131c to wireless coupled to the computer system 110, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of computer processing and storage by improving manufacturing control systems by reducing the amount of energy required to perform calculations and reducing the amount of storage space needed to store data. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. An industrial control system comprising:
one or more computers comprising one or more processors and one or more non-transitory computer readable media, the one or more non-transitory computer readable media comprising instructions stored thereon that when executed cause the one or more computers to:
receive, by the one or more processors, a first sensor output, the first sensor output comprising one or more first data values from a first component within an industrial process;
associate, by the one or more processors, the one or more first data values with a first unit of measure;
receive, by the one or more processors, a second sensor output, the second sensor output comprising one or more second data values from a second component within the industrial process;
associate, by the one or more processors, the one or more second data values with a second unit of measure;
generate, by the one or more processors, a graphical user interface (GUI), the graphical user interface comprising a visual representation of at least the first component and the second component;
generate, by the one or more processors, a first data display on the GUI comprising at least one of the one or more first data values in association with the first component, the first data display comprising the first unit of measure;
execute, by the one or more processors, a transformation of the one or more second data values to obtain one or more transformed data values;
associate, by the one or more processors, the one or more transformed data values with the first unit of measure; and
generate, by the one or more processors, a second data display on the GUI comprising at least one of the one or more transformed data values in association with the second component, the second data display comprising the first unit of measure.

2. The industrial control system of claim 1,
the one or more non-transitory computer readable media further comprising instructions stored thereon that when executed cause the one or more computers to:
generate, by the one or more processors, a visual representation of at least a third component within the industrial process that does not comprise a sensor on the GUI;
calculate, by the one or more processors, one or more equivalent third data values using the one or more first data values and/or the one or more second data values; and
display, by the one or more processors, the one or more equivalent third data values on the GUI in association with the third component.

3. The industrial control system of claim 2,
wherein the one or more equivalent third data values comprise the first unit of measure.

4. The industrial control system of claim 3,
wherein the one or more equivalent third data values are calculated using the one or more first data values and/or the one or more second data values as the one or more first data values and/or the one or more second data values are received in substantially real time.

5. The industrial control system of claim 4,
the one or more non-transitory computer readable media further comprising instructions stored thereon that when executed cause the one or more computers to:
receive, by the one or more processors, one or more time data points associated with a time the one or more first data values and/or the one or more second data values were received;
transform, by the one or more processors, the one or more equivalent third data values into one or more transformed third data values using the one or more first data values and/or the one or more second data values and the one or more time data points;
wherein the one or more transformed third data values comprise a transformed third unit of measure comprising a time rate of change.

6. A system for self-healing data collection upon loss of a data collection signal comprising:
one or more computers comprising one or more processors and one or more non-transitory computer readable media, the one or more non-transitory computer readable media comprising instructions stored thereon that when executed cause the one or more computers to:
receive, by the one or more processors, a first sensor output, the first sensor output comprising one or more first data values from a first component within an industrial process;
associate, by the one or more processors, the one or more first data values with a first unit of measure;
receive, by the one or more processors, a second sensor output, the second sensor output comprising one or more second data values from a second component within the industrial process;
associate, by the one or more processors, the one or more second data values with a second unit of measure; and
generate, by the one or more processors, a graphical user interface (GUI), the graphical user interface comprising a visual representation of at least the first component and the one or more first data values;
wherein if the first sensor output is not received within a pre-determined period of time, the instructions further cause the one or more computers to implement a self-healing operation, the self-healing operation causing the one or more computers to:
calculate, by the one or more processors, one or more equivalent first data values using the one or more second data values;
display, by the one or more processors, the one or more equivalent first data values on the GUI in association with the first component; and
associate, by the one or more processors, the one or more equivalent first data values with the first unit of measure.

7. The system of claim 6,
the one or more non-transitory computer readable media further comprising instructions stored thereon that when executed cause the one or more computers to:
generate, by the one or more processors, a visual representation of at least a third component within the industrial process that is not receiving data from a sensor on the GUI;
calculate, by the one or more processors, one or more equivalent third data values using the one or more first data values and/or the one or more second data values; and
display, by the one or more processors, the one or more equivalent third data values on the GUI in association with the third component.

8. The system of claim 7,
wherein the one or more equivalent third data values comprise the first unit of measure.

9. The system of claim 8,
wherein the one or more equivalent third data values are calculated using the one or more first data values and/or the one or more second data values as the one or more first data values and/or the one or more second data values are received in substantially real time.

10. The system of claim 9,
the one or more non-transitory computer readable media further comprising instructions stored thereon that when executed cause the one or more computers to:
receive, by the one or more processors, one or more time data points associated with a time the one or more first data values and/or the one or more second data values were received; and
transform, by the one or more processors, the one or more equivalent third data values into one or more transformed third data values using the one or more first data values and/or the one or more second data values and the one or more time data points;
wherein the one or more transformed third data values comprise a transformed third unit of measure comprising a time rate of change.

11. An industrial control system comprising:
one or more computers comprising one or more processors and one or more non-transitory computer readable media, the one or more non-transitory computer readable media comprising instructions stored thereon that when executed cause the one or more computers to:
receive, by the one or more processors, a first sensor output, the first sensor output comprising one or more first data values from a first component within an industrial process;
associate, by the one or more processors, the one or more first data values with a first unit of measure;
receive, by the one or more processors, a second sensor output, the second sensor output comprising one or more second data values from a second component within the industrial process;
associate, by the one or more processors, the one or more second data values with a second unit of measure;
generate, by the one or more processors, a graphical user interface (GUI), the graphical user interface comprising a visual representation of at least a third component within the industrial process that does not comprise a sensor;
calculate, by the one or more processors, one or more equivalent third data values using the one or more first data values and/or the one or more second data values; and
display, by the one or more processors, the one or more equivalent third data values on the GUI in association with the third component.

12. The industrial control system of claim 11,
wherein if the first sensor output is not received within a pre-determined period of time, the instructions further cause the one or more computers to implement a self-healing operation, the self-healing operation causing the one or more computers to:
calculate, by the one or more processors, one or more equivalent first data values using the one or more second data values.

13. The industrial control system of claim 11,
the one or more non-transitory computer readable media further comprising instructions stored thereon that when executed cause the one or more computers to:
control, by the one or more processors, a physical attribute of the third component using the one or more equivalent third data values.

14. The industrial control system of claim 12,
the one or more non-transitory computer readable media further comprising instructions stored thereon that when executed cause the one or more computers to:
control, by the one or more processors, a physical attribute of the first component using the one or more equivalent first data values.

15. The industrial control system of claim 11,
the one or more non-transitory computer readable media further comprising instructions stored thereon that when executed cause the one or more computers to:
receive, by the one or more processors, one or more time data points associated with a time the one or more first data values;
transform, by the one or more processors, the one or more first data values into one or more transformed first data values using the one or more first data values and the one or more time data points;
wherein the one or more transformed first data values comprise a transformed first unit of measure comprising a time rate of change.
